(19) United States
(12) Patent Application Publication
(10) Pub. No.: US 2006/0119054 A1
(43) Pub. Date: Jun. 8, 2006

(54) Spacer for snowboard

(76) Inventors: Jurg Kunz, Bilten (CH); Peter Martin, Saaldorf-Surheim (DE)

Correspondence Address: OSTROLENK FABER GERB & SOFFEN, 1180 AVENUE OF THE AMERICAS, NEW YORK, NY, 100368403, US

(21) Appl. No.: 10/543,217

(22) PCT Filed: Jan. 23, 2004
(86) PCT No.: PCT/CH04/00035

§ 371 Date: Nov. 9, 2005

(30) Foreign Application Priority Data
Jan. 24, 2003 (US) 10350621

(51) Int. Cl. B62B 13/00; B62B 15/00

(52) U.S. Cl. 280/14.22

(57) ABSTRACT

The invention is directed to an improved spacer (1) with at least one centre part (2) and at least one lateral part (3) comprising at least two different materials. The at least one lateral part serves as a load transfer and distribution mean between one of a tip or a heel of a snowboard boot (40) and a snowboard (20).

### FIELD OF THE INVENTION

The invention presented herein relates to an improved spacer for snowboards.

### DESCRIPTION OF RELATED ART

The inventors of the invention described herein are also the inventors of the spacer described in the U.S. Pat. No. 6,505,841 (from now on US'841). As described in US'841 it is important when riding snowboards, that the contact between the snowboard and the snowboard boot is as direct as possible so that the rider is immediately in a position to react to the movements of the snowboard and can apply the steering forces as efficiently as possible. Long indirect load paths are disadvantageous. The distance holders and binding plates customary today are very rigid and permit practically no deformations. This, in turn, leads to the fact that the elastic characteristic of a snowboard is lastingly and negatively affected with a directly mounted binding plate.

Various snowboard bindings are known in the art. In the document PCT/US98/06773, for example, a snowboard with adjustable stiffening elements is described. The stiffening elements serve to influence the rigidity and the torsional characteristics of the snowboard and are fixed to the snowboard by means of reversibly releasable connections. From CH 677 191, a snowboard binding is known. This consists of an element, which is connected with the snowboard through a central fixing device. PCT/EP96/02980 divulges a further binding for snowboards, in the case of which also the fixation and with this the transmission of the forces between snowboard and rider takes place in the middle of the snowboard. From FR 2 740 983, a binding for snowboards is known, the base plate of which is directly fixed to the snowboard. The transmission of the forces takes place in the middle of the snowboard. U.S. Pat. No. 5,520,405 shows a further binding for snowboards with a bayonet type lock. Affixed to the snowboard boots at the front and back are supports, which serve as walking aids.

From DE 1 96 19 676, a plate for snowboard bindings is known. This consists of a middle part, which is located at the centre of two ring-shaped lateral parts, which are arranged concentrically one above the other. The lateral parts can be connected together, one above the other, in different angular positions such that the angle between a binding and a snowboard is variable.

### SUMMARY OF THE INVENTION

It is an objective of the present invention to provide an improved spacer for a snowboard which is compatible with several bindings and snowboards known from the state of the art. It is a further objective of the invention to provide a spacer which absorbs and dampens in an improved way shocks and vibrations as they occur while riding a snowboard. It is also an objective of the present invention to provide a spacer which does not negatively influence the snowboard, neither the stiffness, flexibility nor the geometrical shape. It is still a further objective of the present invention to provide a simplified mounting mechanism to connect different bindings with a snowboard without negative loads and forces influencing the snowboard and it's hard points (e.g. tapholes).

A preferred embodiment of the invention divulged here comprises a spacer having at lease one central part and at least one lateral part which comprises a dual density material construction for shock absorption and dampening. The central part comprises fixing means to provide a direct or indirect mechanical connection between a binding and a snowboard through the central part. The fixing means preferably are connectable with different binding types available on the market. The at least one lateral part is preferably affixed to the central part and serves as a load transfer mean between one of a tip or a heel of a snowboard boot and a snowboard. Alternatively or in addiction the at least one lateral part is affixed to the snowboard and/or the binding.

To achieve an optimized absorption of vibrations and shocks while riding, the at least one lateral part comprises at least one region made of a first material and at least one region made of a second material having in general different material constants such as density and elastic modulus then the first material. The first and the second material preferably are out of the group of injection mouldable or pressable plastic or metallic materials. By proper choosing the different density and elastic modulus of the materials combined in a lateral part, best performance and damping is achieved. To obtain optimized results for damping the several materials are preferably arranged penetrating each other three-dimensional. This can be well achieved e.g. by injection moulding the first material into a first cavity and in a second step injection moulding the second material in a second cavity around the first material. Specific results regarding damping and shock absorption are obtained by using materials which are combinable (forming a compound). Different results are obtained by using materials which are not combinable (which are not forming a compound). Preferred materials are Polycarbonate, Polyamide, Polyurethane, Rubber and elastomeric Material in general). These materials are joined together by mechanical connection such as an undercut. The hardness of a soft component is preferably below 60 to 70 shore and the hardness of a hard component is preferably above 60 to 70 shore. A tight connection is achieved if the material injected first is forming part of the mould for the material injected second. Due to the friction which occurs along the interface between the different material components which are not combinable very good damping and shock absorption is obtainable. The ability to absorb shock and vibration is adjustable by the relative and absolute thickness of the material.

A preferred embodiment comprises a lateral part with an area made of a fist material component and an area made of a second material component, whereby the fist material is relatively rigid compared to the second material and the first and the second material are not combinable (are not forming a compound). In the region where the second material component is in interaction with the fist material component, the first material component is forming a regular or irregular grid like structure with round or straight sides. This grid like structure is surrounded part wise or completely by the second material component, forming a tight connection. Depending on the design of the interface the damping behaviour is adjustable. The lateral part is preferably made such that the material component moulded first forms at least part of the cavity for the material component moulded second. A further connection between several materials is achieved by releasable or non-releasable snap connections. Mechanical behaviour of such connections is different. In a further embodiment the lateral part comprises a gas or gel filed pad which is in direct or indirect contact with the binding/shoe of the rider and/or the snowboard and/or the lateral part. The filed pad can be incorporated in the lateral part or formed as a separate element for shock absorption or damping.

The at least one lateral part is adjacent to the central part on one or on several sides, or may be arranged island-like completely surrounded by the at least one lateral part. The lateral part is preferably arranged adjustable in distance and orientation with respect to the central part and the snowboard. The at least one lateral part is preferably connected to the central part by a standardized interface. The lateral part has a shape which is optimized to distribute the load or reaction force from and to the rider to distinct areas or over a large surface, preferably along the edges of the snowboard.

The at least one central and the at least one lateral part of the spacer are in an active combination with the snowboard and/or with the snowboard binding and/or with the snowboard boot, so that the forces are optimally transmitted between their point of origin and their point of effect. As a result of the locating of the spacer in the region of the binding plate, the bearing area for the snowboard boots, particularly in the case of narrow snowboards or snowboards having surface indentations, is purposefully enlarged. The distance between the snowboard boot and the snowboard is increased in an advantageous manner. This has the effect of a better load introduction into the snowboard and/or into the snowboard boots and, especially in the case of making curves, makes a better build-up of pressure between the edges and the substratum possible. Short load paths are preferred.

The elevation of the at least one lateral part which serves as load transfer and/or load distribution mean between a snowboard boot/binding and a snowboard may be sickle-shaped as described in US'841. Alternatively the elevation is round, oval, square, V- or X-shaped, forming a connection between a shoe and/or a binding of a rider and the snowboard. The at least one lateral part can be made out of several parts. Load distribution is influenced by ratio between the interaction surface snowboard binding/boot and the interaction surface lateral part and snowboard.

The spacer furthermore is compatible with the customary standard hole patterns of snowboard bindings, such as 4×4, 3×3 patterns or arranged in a line or a central connection point, as well as with the customary connection surfaces of soft, alpine, and step-in bindings. In particular, because of the fact that it is made of several parts and is adaptable, the spacer is also suitable for snowboards that do not have an even surface on their top side.

### BRIEF DESCRIPTION OF THE DRAWINGS

The invention is described according to preferred embodiments as shown in the following drawings. These illustrate:

FIG. 1 a first embodiment of a spacer in a perspective view;

FIG. 2 a section of lateral part of a spacer;

FIG. 3 a cut through a second embodiment of a spacer and a snowboard;

FIG. 4 a third embodiment of a spacer;

FIG. 5 the spacer according to FIG. 1 in a side view;

FIG. 6 a cut view through the spacer and a binding plate;

FIG. 7 the spacer according to FIG. 1 in a bottom view.

### DETAILED DESCRIPTION OF THE EMBODIMENTS

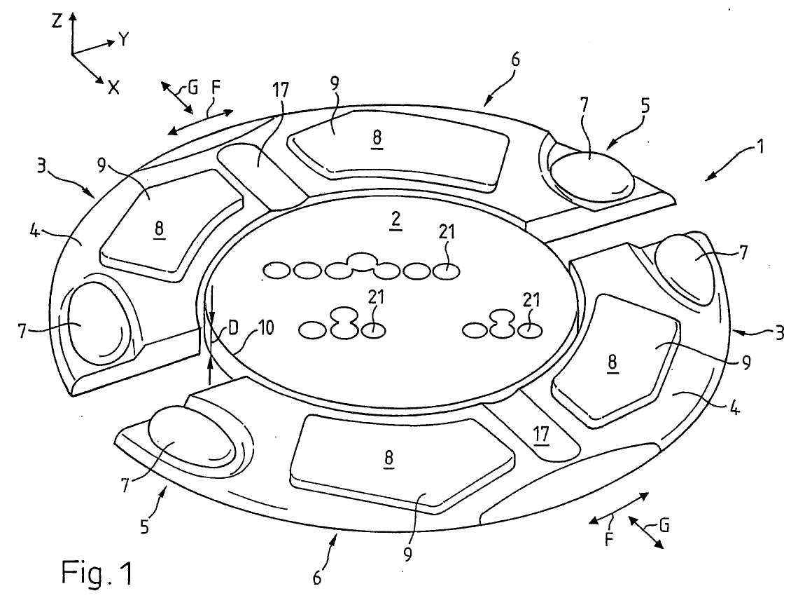

FIG. 1 illustrates a first embodiment of a spacer 1 in a perspective view. The spacer 1 comprises a centre part 2 and two sickle shaped lateral parts 3 which are arranged adjacent to the centre part 2 adjustable radially and tangentially (arrows F, G) with respect to the centre part 2 in a certain distance such that they are adoptable to the width of a snowboard (not displayed). The horizontal projection of the centre part 4 of this embodiment is round, but may be different, if appropriate. The horizontal projection of the lateral parts 3 is essentially sickle shaped and is corresponding along the inner side with the edge 10 of the centre part 2. The lateral parts 3 have a dual density construction comprising two materials with different material constants. A first material is forming a first part 4. Arranged at a first and a second specific location 5, 6 first and second pads 7, 8 are visible made of a second, in this embodiment elastomeric, material having a lower modulus of elasticity than the first material. The second pads 8 are protruding locally over the upper surface of the first part 4 having an essentially flat upper area 9. The second pads are serving as footstep, respectively interaction zone for a binding (not shown in detail). They may have a patterned structure surface which is providing e.g. increased grip or better load transfer. The first pads 7 are arranged adjacent to the edge of the sickle shaped first part and are having a convex shape locally protruding over the surface of the first part. The first pads 7 are taking influence on the mechanical behaviour regarding bending, torsion and/or damping of vibrations of the surrounding structure of the first part 4. They are characteristic for the capability of mechanical vibrations and their absorption thereof (half-life period). The spacer, especially the at least one lateral part, is forming a smooth interface between a rigid binding and a relatively flexible snowboard transmitting forces even, without influencing the flex of the snowboard. The at least one lateral part is made flexible (deformable) such that it is acting as smooth interface between the snowboard and the binding/boot.

In this embodiment the first and the second pads 7, 8 and the first part 4 are developed three-dimensional penetrating each other at least partly. Alternatively the first part 4 and the pads 7, 8 may be glued or clipped together along corresponding surfaces, even though the mechanical characteristics of such a construction is different. The centre part 2 comprises at least one mean for affixing directly of indirectly a snowboard binding, available on the market, to a snowboard. Several means for affixing different snowboard bindings to different snowboards may be incorporated such that compatibility and/or combinability of different products are guaranteed. The means are preferably developed as opening or taphole or screw insert. The centre part may also be part of or integrated into a snowboard.

In the central part 2 means 21 for affixing the spacer 1 to a snowboard (not visible in this figure) are incorporated. In this embodiment the means 21 are built out as through hole suitable to receive a direct mechanical connection (e.g. by screw and/or screw extension according to US'841) between a snowboard and a binding. A bending mean 17, here incorporated as impression, influences the bending property of the lateral part 3

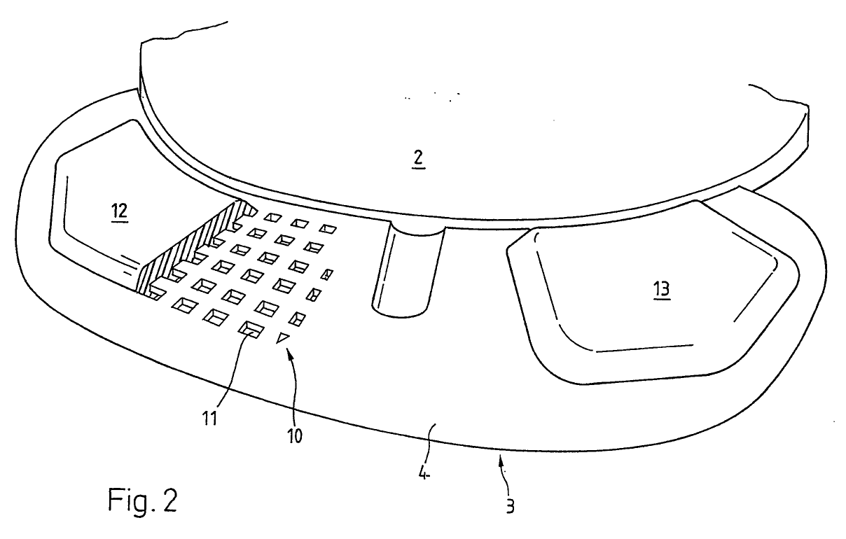

FIG. 2 is showing in a simplified manner a lateral part 3 adjacent to a centre part 2 in a perspective view. The lateral part 3 comprises a shell-like injection moulded first part 4 which serves as a base structure for the lateral part 3. Alternatively the interior of the first part 4 can be hollow or filled out by the same or different materials. This first part 4 comprises in an area 10 openings 11 which are serving as an undercut. A third and a forth pad 12, 13 are mechanically connected to the first part 4 by three-dimensional interaction. The third pad 12 is displayed only part-wise in a cut view to visualize the three-dimensional interaction of the third pad 12 with the first part 4. By such a connection of the several material components very efficient damping and shock absorption may be achieved. Alternatively or in addition several parts may be connected by gluing or by snap- and/or clamping-connections. In this way different damping and shock absorption may be achieved.

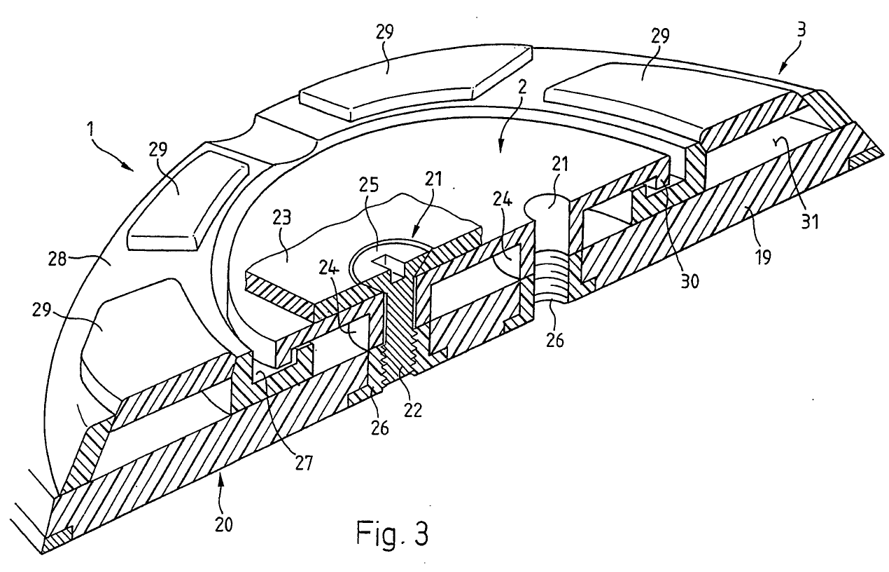

FIG. 3 is showing a section cut through a spacer 1 and a snowboard 20 in a perspective view. In the snowboard 20 the cut passes through two inserts with an internal thread (hard points) 26 which serve for fastening a binding (not displayed) and/or a spacer 1 to the snowboard 20. The inserts 26 are arranged extending through a core 19 of the snowboard from the lower to the upper side. In this embodiment the centre part 2 has openings 21 which have the shape, respectively are arranged in a way that they fit with whole patterns of different bindings and snowboards known from the state of the art such as 3×3 and 4×4. In a further embodiment they are arranged in the middle of the centre part 2 in a line suitable for snowboards with hard points which are arranged along a centre line of a snowboard 20. The centre part may be made such that it is suitable to serve as an adapter to allow combination of several types of bindings and snowboards.

A section of a binding 23 and a screw 22, which is arranged in one of the openings 21 and connects the section of the binding 23 with the snowboard 20, is displayed. The centre part 2 of the spacer 1 has a collar 24 arranged around the openings 21. This collar 24 is built out such that it is part of a mechanical connection between the screw head 25, respectively the binding 23 and the insert 26 in the snowboard 20 eliminating the tendency of pulling out the insert 26 out of the snowboard 20. Due to this mechanical connection between the screw head 25 and the insert 26 by the collar 24, the stress level in the snowboard 20 is significantly reduced, compared to solutions known from the state of the art. Instead of single screw 22 connecting the binding 23 and the insert 26 it is possible to use a screw extension as described in U.S. Pat. No. 6,505,841 of the same inventors.

The lateral part 3 of this embodiment has a ring-like inner shape with a radial rim 27 which is in the fixed position of the spacer 1, when the screws 22 are fastened, clamped between the centre part 2 and the snowboard 20. The outer shape of the lateral part 3 is round of oval such that the lateral part 3 is adjustable in orientation with respect to the central part 2. The lateral part 3 comprises a first part 28 consisting of a first material and several areas 29 consisting of a second material. The first material of the first part 28 and the second material of the areas 29 are in this embodiment combinable such that they are forming a compound. As it can be seen the lateral part 3 is hollow on the under side. In this embodiment due to the oval outer shape of the lateral part 3 the width of the spacer is adjustable to the width of the snowboard.

By tightening the screw 22 the lateral part 3 is clamped between a vertically extending rim 30 of the central part 2 and the upper surface 31 such that the lateral part is securely fixed. The at least one lateral part may be fastened by other methods, e.g. directly to the snowboard or the central part. The materials used in this embodiment are combinable such that they form a unitary part.

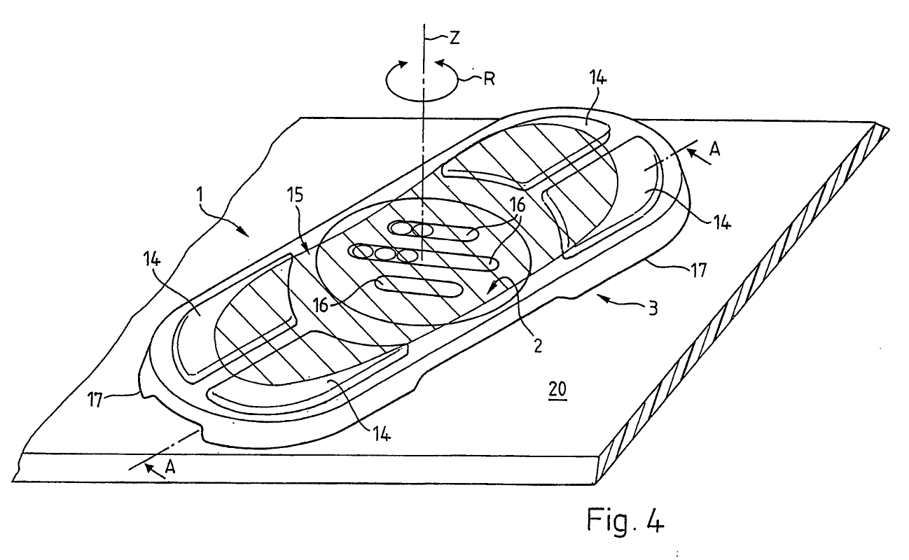

FIG. 4 is showing a further embodiment of a spacer 1 comprising a centre part 2 and a lateral part 3. The centre part 2 is arranged island-like in the middle of the lateral part 3. The lateral part 3 comprises a first part 4 made of a first material and four pads 14 which are serving in combination with the first part 4 as direct or indirect interaction mean between a snowboard boot, indicated by a hatched area 15 and a snowboard 20. The centre part 2 comprises here several openings 16 for affixing a snowboard binding to a snowboard. The openings 16 of this embodiment are built out as elongated whole with straight edges. Alternatively the openings are having bent or irregular edges, depending on the achieved compatibility with different snowboards/bindings. The lateral part 4 has lateral projection which is essentially oblong with two longer and two shorter edges and comprises distinct interaction areas 17 which serve to distribute interaction forces into the snowboard 20. The lateral part 3 is rotatably adjustable (arrow R) around a vertical axis z after releasing the screws fixing the binding. If appropriate this embodiment can be built out as a single part.

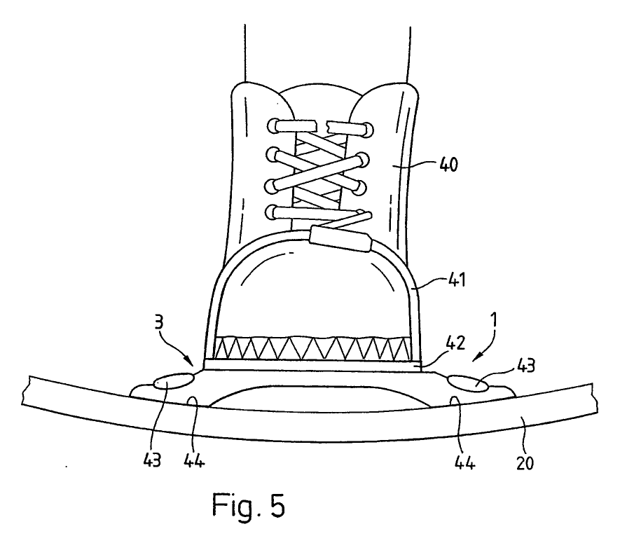

FIG. 5 illustrates the preferred mechanical functionality of a spacer 1. A snowboard boot 40 and a binding 41 with a rigid binding plate 42 is connection to the spacer 1. The spacer 1 is connected to a snowboard 20 which is drawn in a deformed state as it typically occurs while riding. A lateral part 3 is acting as a load transfer and load distribution mean. The lateral part 3 is built out such that it is capable to mechanically interconnect a rigid binding plate/boot 42, 40 to a flexible snowboard 20 over an extensive area, even when the snowboard is in a deformed state. An Insert of a second material 43 according to the present invention is influencing the mechanical behaviour the lateral part. The lateral part 3 may be in mechanical connection with the snowboard 20 over a single or over several interaction areas 44. If appropriate the at least one lateral part is exchangeable.

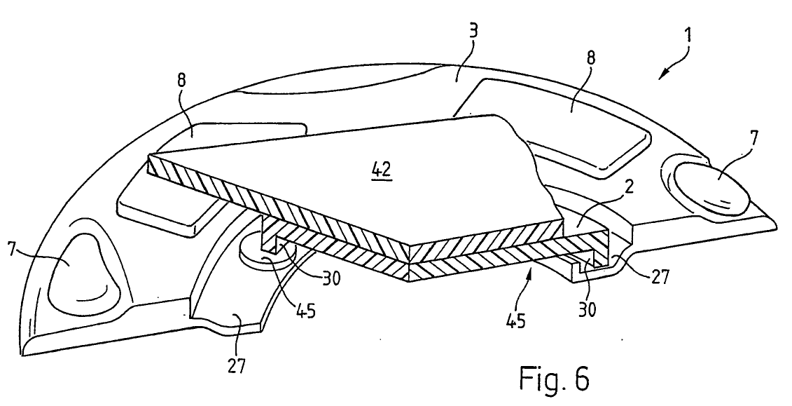

FIG. 6 illustrates a cut through a spacer according to FIG. 1 and a binding plate 42. In the radial rim 27 elastic elements 45 are incorporated. The central part 2 is resting on elastic elements 45. The binding plate 42 is in normal state in contact with the central part 2 and the second pad 8 of the lateral part 3. The elastic elements 45 are, due to their embodiment, relatively easy compressible compared to the second pad 8 such that under external force, the binding plate is mainly in mechanical contact with the lateral part 3. By this the main load path of the compression loads is guided into the lateral part 3 and from this distributed into a snowboard (not visible in this figure).

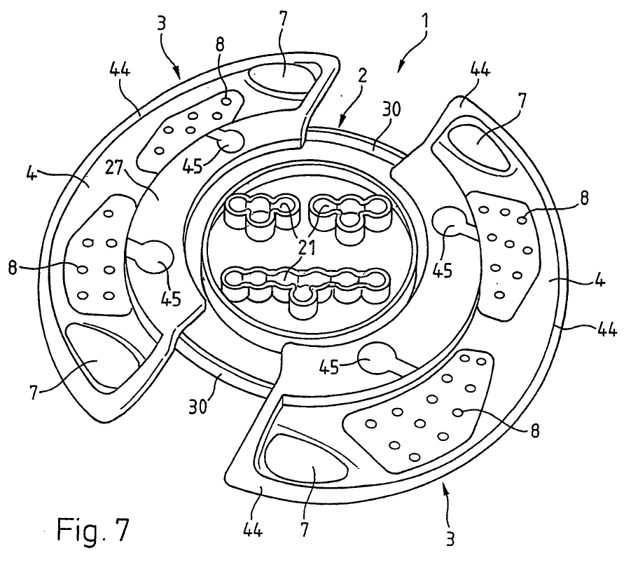

FIG. 7 illustrates the bottom of the spacer according to FIGS. 1 and 6. The numbers are therefore according to FIGS. 1 and 6. The lateral parts 3 are in this embodiment made as shells such that they are flexible and adjustable. The interaction area 44 of this embodiment is essentially kidney-shaped with various wall-thicknesses. As it can be seen the first pads 7 are extending to the back of the lateral part 3. Compared to this the second pads 8 extend only at distinct areas to the back of the lateral part by three-dimensional interaction with the first part 4.

If the spacer 1 is mounted on a snowboard (not visible in this figure), the radial rim 27, respectively the elastic elements 45, of each lateral element 4 is clamped between the snowboard and the vertical rim 30 of the centre part 2. In the centre of the centre part 2 holes 21 are visible which are suitable to affix the spacer 1 to a snowboard and a binding.

From the above-described embodiments of the present invention, it is apparent that the present invention may be modified as would occur to one of ordinary skill in the art without departing from the scope of the present invention. Changes and modifications of this system contemplated by the present preferred embodiments will be apparent to one of ordinary skill in the art. Thus, it is apparent that the invention may be varied in many ways without departing from its spirit and scope, and all such modifications would be obvious to one of ordinary skill in the art.

1. Spacer (1) with at least one centre part (2) and at least one lateral part (3) comprising at least two different materials, which at least one lateral part (3) serves as a load transfer and distribution mean between one of a tip or a heel of a snowboard boot (40) and a snowboard (20).

2. Spacer (1) according to claim 1 characterized in that the at least one lateral part (3) comprises a first part (4) made of a first material and a second part (7, 8) made of a second material, wherein the first part (4) and the second part (7, 8) are three-dimensional interacting.

3. Spacer (1) according to claim 2 characterized in that the hardness of the first material is below shore 60 and the hardness of the second material is above shore 60.

4. Spacer (1) according to claim 1 characterized by a central part (2) and two sickle-shaped lateral parts (3) wherein each of said lateral parts (3) is comprising a first part (4) made of a first material and two peripheral first pads (7) and two internal second pads (8) made of second material, wherein said internal second pads (8) are serving as interaction mean with a snowboard binding (41) and/or a snowboard boot (40).

5. Spacer (1) according to claim 5 characterized in that the hardness of the first material is below shore 60 and the hardness of the second material is above shore 60.

6. Spacer (1) according to claim 4 characterized in that the second pads (8) are protruding over the first part (4).

7. Spacer (1) according to claim 4 characterized in that the lateral parts (3) have a shell-like structure.

8. Spacer (1) according to claim 1 characterized by a central part (2) and a lateral part (3) arranged rotatable around the centre part (2).
